(19) United States
(12) Patent Application Publication
(10) Pub. No.: US 2007/0155266 A1
(43) Pub. Date: Jul. 5, 2007

(54) Absorptive cloth

(75) Inventors: Chung-Hu Hsiao, Taichung City (TW); Den-Yong Lin, Taichung County (TW); Ching-Hsi Jen, Taichung City (TW)

Correspondence Address: BROWDY AND NEIMARK, P.L.L.C.;624 NINTH STREET, NW, SUITE 300, WASHINGTON, DC, 20001-5303, US

(73) Assignee: Tiong Liong Industrial Co., Ltd., Taichung Hsien (TW)

(21) Appl. No.: 11/320,837

(22) Filed: Dec. 30, 2005

(51) Int. Cl. B32B 5/22; B32B 5/02

(52) U.S. Cl. 442/59; 442/76

(57) ABSTRACT

Disclosed is an absorptive cloth, which has an absorptive layer made out of a fiber material containing nanobon and a hydrophilic absorptive material, and a diffusion layer being made out of polyester, nylon, cotton or polypropylene fibers.

### BACKGROUND OF THE INVENTION

1. Field of the Invention

The present invention relates to cloths, and more particularly to an absorptive cloth that is highly absorptive to stinky fluid.

2. Description of the Related Art

Regular cloths use the capillary effect of the fibers to guide attached water drops into the inside of the cloth body. This water absorbing speed is low. A water diffusion trace on the surface of the cloth body can be seen. When the body touched the water diffusion trace area, the user will feel cold and wet, i.e., uncomfortable.

In order to eliminate wet, sticky, and non-breathing problems, absorptive fibers and cloths are developed. These absorptive fibers are made by improving the hydrophilic property of hydrophobic fibers by means of one of the following two ways. The first way is to add hydrophilic polymers to fibers chemically. The second way is change the structure or cross section of the yarns, i.e., to form a porous and/or hollow structure in fibers during spinning, making the fibers absorptive and improving the hydrophilic property of the fibers. These methods improve the water absorbing speed of the fibers. These absorptive fibers are commonly used for making underwear, sports wear and shoe linings. However, absorbed water is still kept among hydrophobic fibers, causing the cloth wet and cold.

Further, the body of a person will expel stinky substances such as NH₃ and H₂S. As it is known that as NH₃ and H₂S cannot exist in air independently, and can easily be surrounded by water in air. The reaction equations are: as NH₃+(H₂O)ₓz,900 NH₃(H₂O)ₓ; H₂S+(H₂O)ₓ [symbol] NH₃(H₂O)ₓ. When the body expels NH₃ and H₂S, NH₃ and H₂S will soon be surrounded by water in air, establishing the aforesaid equations. Therefore, the best way to remove stinky smell from the body is to remove water that surrounds NH₃ and H₂S. However, commercially available cloths are not workable in this way.

### SUMMARY OF THE INVENTION

The present invention has been accomplished under the circumstances in view. It is one object of the present invention to provide an absorptive cloth, which absorbs and diffuses water rapidly, keeping the cloth body dry.

To achieve this and other objects of the present invention, the absorptive cloth comprises a cloth body, which is comprised of an absorptive layer and a diffusion layer. The absorptive layer is made out of a fiber material containing nanobon and a hydrophilic absorptive material. The diffusion layer is made out of polyester, nylon, cotton or polypropylene fibers.

### BRIEF DESCRIPTION OF THE DRAWINGS

FIG. 1 is a sectional view of an absorptive cloth according to the present invention.

FIG. 2 is a schematic drawing showing the water absorbing and diffusing action of the absorptive cloth according to the present invention.

### DETAILED DESCRIPTION OF THE INVENTION

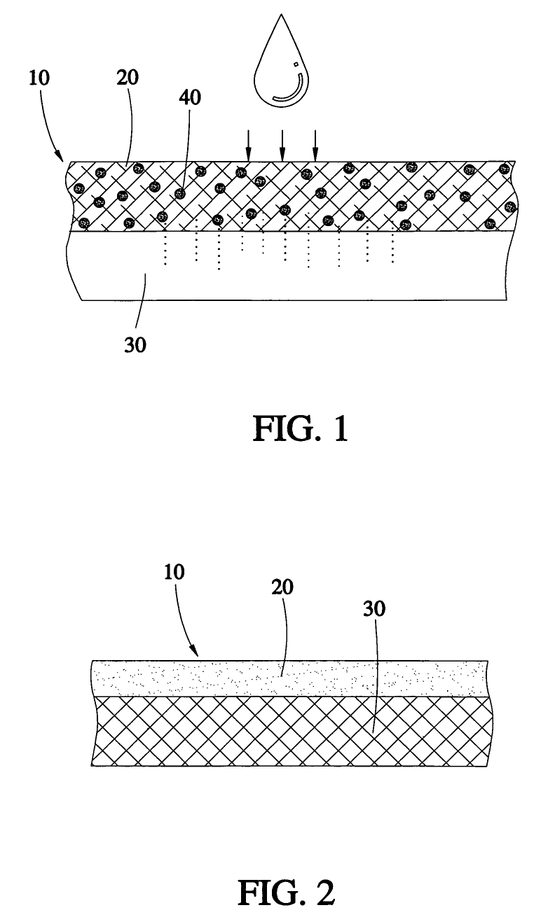

Referring to FIGS. 1 and 2, an absorptive cloth in accordance with the present invention is shown comprised of a cloth body 10. The cloth body 10 comprises an absorptive layer 20 and a diffusion layer 30. The absorptive layer 20 and the diffusion layer 30 are bonded together in a stack. The absorptive layer can be made out of polyester, nylon, cotton or polypropylene fiber yams by plain weaving or knitting, having embedded therein bamboo nanobon 40 and hydrophilic absorptive material such as sodium iron toumaline or the like. The diffusion layer 30 is made out of polyester, nylon, cotton or polypropylene fibers. As an alternate form of the present invention, the absorptive layer 20 is made of out polyurethane and bamboo nanobon mixture and directly coated on the diffusion layer 30.

According to a research made by Technical Department of Economic Affairs of Taiwan, bamboo nanobon has a super absorptive power, and the surface area of bamboo nanobon is about 3 times over an equal volume of wooden nanobon. Bamboo nanobon has a fine porous structure that absorbs and decomposes methyl alcohol, sulfide, nitride, benzene, and phenol.

According to a test made by Taiwan Textile Research Institute, ammonium was soon surrounded by water in air, thereby forming water drops, and the concentration of ammonium dropped naturally from 40 ppm to 28 ppm after 24 hours. However, after the use of an absorptive cloth made according to the present invention, the concentration of ammonium dropped drastically from 40 ppm to 3 ppm at either side of the absorptive cloth, i.e., the absorptive rate was as high as 89%. This test report approves the effectiveness of the present invention.

As indicated above, the porous structure of bamboo nanobon is highly absorptive to water. The invention uses the absorptive property of nanobon to enhance the absorptive power of the absorptive cloth. When water drops touched the surface of the absorptive cloth, water drops are immediately absorbed by bamboo nanobon in the absorptive layer. Further, the hydrophilic absorptive material such as sodium iron toumaline immediately guide the absorbed water to the diffusion layer that diffuse absorbed water outwards, enabling absorbed water to be evaporated. Therefore, the cloth body of the absorptive cloth can soon be kept in dry.

The absorptive cloth of the present invention is practical for making clothes. When the body expels ammonium, ammonium will soon be joined to water in air or the sweat expelled from the user's body, and the clothe made of the absorptive cloth of the present invention will soon absorb ammonium-contained water and sweat and diffuse absorbed ammonium-contained water and sweat in different directions toward the outside for enabling ammonium-contained water and sweat to be soon evaporated into the outside open air. Therefore, the clothes can be kept dry without smell.

Although a particular embodiment of the invention has been described in detail for purposes of illustration, various modifications and enhancements may be made without departing from the spirit and scope of the invention. Accordingly, the invention is not to be limited except as by the appended claims

1. An absorptive cloth comprising a cloth body, said cloth body comprising an absorptive layer and a diffusion layer, said absorptive layer being made out of a fiber material containing nanobon and a hydrophilic absorptive material, said diffusion layer being made out of one of polyester, nylon, cotton and polypropylene fibers.

2. The absorptive cloth as claimed in claim 1, wherein said absorptive layer is made by knitting.

3. The absorptive cloth as claimed in claim 1, wherein said absorptive layer is made by plain weaving.

4. The absorptive cloth as claimed in claim 1, wherein said absorptive layer containing nanobon particles is made out of one of polyester, nylon, cotton and polypropylene fibers.

5. The absorptive cloth as claimed in claim 1, wherein said absorptive layer is a layer formed of a polyurethane and nanobon mixture.
